(19) United States
(12) Patent Application Publication
(10) Pub. No.: US 2003/0065943 A1
(43) Pub. Date: Apr. 3, 2003

(54) Method and apparatus for recognizing and reacting to denial of service attacks on a computerized network

(76) Inventors: Christoph Geis, Hattersheim (DE); Eberhard Pausch, Wettenberg (DE); Thomas Soysal, Walldorf (DE)

Correspondence Address: PATENT DEPARTMENT, LARKIN, HOFFMAN, DALY & LINDGREN, LTD., 1500 WELLS FARGO PLAZA, 7900 XERXES AVENUE SOUTH, BLOOMINGTON, MN, 55431, US

(21) Appl. No.: 09/966,019

(22) Filed: Sep. 28, 2001

(51) Int. Cl. G06F 11/30

(52) U.S. Cl. 713/201; 709/224

(57) ABSTRACT

The invention refers to a procedure for recognizing and refusing attacks on server systems of network service providers and operators by means of an electronic intermediary device (4) installed on a computer network. This electronic intermediary device operates a computer program as well as a data carrier to realize the advantaged of the present invention. In addition, the present invention applies to any computer system connected to a network such as Internet (6), an intranet, a virtual private network and the like, regardless whether such network contains just one computer or many computers configured as a server computer (2) or as a client computer and also applies to a computer program product containing computer codes for recognizing and refusing attacks on server systems, and provides:

defense against DoS and DDoS attacks (flood attacks)

link level security,

examination of valid IP headers,

examination of the IP packet,

TCP/IP fingerprint protection,

blocking of each UDP network packet,

length restrictions of ICMP packets,

exclusion of specific external IP addresses,

packet-level firewall function, and

protection of reachable services of the target system.

The present invention thus guarantees a high degree of security and protection against DoS and DDoS attacks.

### FIELD OF THE INVENTION

The present invention relates to methods and apparatus for recognizing and reacting to denial of service attacks, and more particularly, to such methods and apparatus directed to handling of so-called denial of service (DoS) and distributed denial of service (DDoS) attacks upon a computer network using an electronic intermediary device adapted to monitor data packets passing in and out of the computer network.

The invention relates to a technique for the recognition of and defense against attacks on server systems of network service providers and carriers by using a virtually non-detectable electronic device integrated into a computer network. This electronic device contains specially adapted computer software and utilizes a data medium containing computer software to protect the network from DoS and DDoS attacks. Furthermore the invention relates to a computer system which is connected to a network like the Internet, an intranet, an extranet, a virtual private network and the like containing one or more computers which are configured as server computers or client computers. A computer software program containing operative computer software codes for the recognition of and defense against attacks on server systems of network service providers and carriers according to the present invention is achieved by the electronic device integrated into the computer network which contains such computer software according to the present invention.

Worldwide networking participation by companies continues to grow at a rapid rate. An ever-growing number of companies increasingly believes in the apparently unlimited prospects in the fields of online marketing and e-business. Unfortunately, also increasing are the odds that the network servers of well-known companies and financial institutions can be blocked by DoS and DDoS attacks originating from and passing through the networks.

The significance of the Internet as the electronic marketplace for the e-commerce activities of many companies is growing more and more. Nevertheless the threat on company networks by DoS and DDoS attacks (both of which refer to blocking access or utilization of a computer or the service process running on it) is also growing excessively. Frequently, considerable financial damage is done quite easily even without actual intrusion of so-called hackers who mount such attacks into the secure system environment of companies merely by successfully blocking the access to or utilization of an online business of such companies (e-commerce /e-business). Many approaches for mastering the solution for this problem fell far behind the expectations. One of the reasons is that so far there has been no real method of detection for DoS and DDoS attacks which is principally the only chance of defense in a system environment affected by such attacks. Another problem arises from the nature of the Internet itself as a very fault tolerant, almost uninterruptible communication mechanism. This results in the nearly hopeless situation of only being able to prevent the cause of DoS and DDoS attacks if absolutely all of the worldwide network providers implement uniform restrictive measures for stopping such attacks. Among other things this is a principle reason that all local and national attempts to prevent DoS or DDoS attacks to date have been unsuccessful or having only very limited success.

As is generally known, the Internet is an international network of technical components such as switches, routers and transmission components with multiple routing and the like. Therefore often it is easily possible for hackers to paralyze single servers or complete networks or network regions. Local or national measures hardly promise an effective prevention because the international network of routers, network providers and the preferred call-by-call connections makes it quite easy for the hackers to find a way for a feasible attack strategy. Even if there are no direct damages by loss or manipulation of data or unauthorized copying of data, the loss of reputation itself is oftentimes enough to severely damage a company.

Computer programs which help execute such attacks are available via the world wide web (WWW) for free. They may be downloaded by hackers at any time. Most of these feared attacks take advantage of technical flaws in the data transmission protocols which are the basis of the communication in the Internet. Mostly the affected computers are stressed with such a huge number of pretended requests so that serious requests can no longer be processed. As a result the affected computer seems to be inactive to the real customer.

Some well-known measures for protecting or preventing DoS and DDoS attacks follow.

In the local environment of the network carriers and providers preventative measures making DoS and DDoS attacks more difficult could be taken by active blocking of bogus, faked or copied IP addresses. That is because many such attacks use bogus, faked or copied IP sender addresses (so-called “IP spoofing”) to prevent detection of the hacker or at least make such detection more difficult. By means of appropriate technical rules in the networking infrastructure of the network carriers the network providers can reduce IP Spoofing significantly so that bogus, faked or copied IP packets from their own service environment are no longer passed on to other users of the Internet. Each organization that is connected to a network provider has at its disposal a specific range of IP addresses. Each IP packet which is sent from this organization to the Internet must have a sender address from this range. If not, it is almost certainly a bogus, faked or copied IP address and the associated IP packet should not be passed on by the network carrier. That is, a packet filtering mechanism regarding the sender addresses should be performed before passing the IP packets to other users of the Internet. IP spoofing within the permitted address range of the organization is still possible but the range of possible sources is thus limited to the single organization. In addition to this the operation of so-called “anonymous hosts” should be revised worldwide and restricted or prohibited as far as possible. But this is extremely costly concerning organization, time, law and money.

So far the servers have often very limited abilities to resist against the practiced DoS and DDoS attacks. Some systems can withstand these attacks a little longer, some systems only very shortly. Unfortunately at this point in history, longer lasting DoS and DDoS attacks are virtually always successful.

Furthermore, conventionally used packet filtering solutions often don't help protect against DoS and DDoS attacks (or they are affected so much themselves that they lose their protective effect quite rapidly) at least with longer lasting attacks. Also, numerous attack detection systems are too far removed from the actual attack because they only detect the high-level network traffic and warnings they issue often mostly lead to reactions that fail for arriving too late.

To successfully address an incoming DoS or DDoS attack the ability to quickly react is of primary importance. Only then is it possible to take effective measures, perhaps even promptly identify the attacker, and to ultimately return to normal service as soon as possible. In an emergency plan a practical escalation procedure must be established. Necessary data for the escalation procedure include, among other things, emergency contact person, responsible technical person, alternative communication paths, priority action directives and storage places for all needed resources and sufficient backup media.

The servers of the carriers may be misused as agents of a DoS attack. To accomplish this the attacker installs harmful software taking advantage of well-known weak points. Therefore the carriers have to configure their servers in a careful and safe manner. Network services which are not necessary should be deactivated and those which are necessary should be secured. Adequate password and access facility security as well as timely changes of (especially default) passwords must be assured.

Many web pages posted on the Internet by now are only usable with browser options that are questionable under security aspects because they may be misused by an attacker.

Many content providers make programs and documents available on the Internet. If an attacker succeeds in installing a so-called Trojan Horse the attacker can anticipate wide distribution within a short time. This tactic is tempting to attackers (especially with DDoS attacks) because a huge amount of hosts is necessary for an efficient attack.

Hosts of end users are usually not targets of DoS attacks. On the other hand these hosts may be used by attackers to install harmful software which later enables remotely controlled DoS attacks at arbitrary hosts.

Hosts of end users may be misused as agents for attacks. These agents can be installed on individual hosts most simply via computer viruses, Trojan Horses or other active contents (e.g., applets or software plug-ins). Therefore a reliable and current virus protection as well as the switching off of active contents in the browser is absolutely required. If necessary the use of utilities for online protection of the clients (e.g. PC-firewalls) may be implemented. However often computer viruses (esp. new ones) are not detected and eliminated adequately.

Time and again new weak points which are relevant to security are discovered in operating systems and server software and are fixed by the manufacturers a little later by updates or patches. For reacting as quickly as possible it is necessary to constantly watch software manufacturers for updates. The relevant updates must be installed as quickly as possible so that the recognized weak points are fixed.

To protect a host from risks and dangers considerable know-how is necessary for implementing an efficient information systems security configuration. Therefore administrators have to be trained sufficiently and extensively.

Certainly the measures for blocking IP spoofing by attackers are not implemented quickly world wide and uniformly by the numerous network carriers and providers. With respect to other protection measures described above, it is possible to reach quite a high level of success against DoS and DDoS attacks. Nevertheless it is not possible by now to reach a satisfactory result with the recognized methods.

### SUMMARY OF THE INVENTION

The primary goal of the present invention is to apply apparatus and create methods for the recognition of and defense against attacks on server systems of network service providers and carriers of the kind mentioned earlier. With these methods DoS and DDoS attacks can be recognized and eliminated so that a high degree of security and protection against DoS and DDoS attacks is attained and the computer or the computer system is kept in a stable and efficient state continuously.

By way of example and without limitation, the invention addresses and solves the primary goal set forth above by the following components and steps.

By providing a system for the defense against DoS and DDoS attacks (flood attacks) comprising the following steps:

Registering each IP connection request (IP SYN); that is, each IP connection request is registered and while the registered data packet is checked for validity (and/or as the services of a target system are confirmed) a periodic acknowledgement signal (SYN ACK) is sent to preserve the connection against time restrictions, or “timeouts” (as defined in the applicable IP protocol); and

Receiving each registered data packet after the connection to the target system is initialized and the received data packet are forwarded to the target system for further processing if the verification was successful and the expected acknowledgement (SYN ACK) as well as a consecutively following valid data packet was received from the requesting external system.

In addition to or in lieu of the above steps, one or more of the following steps may be implemented:

Checking link-layer security of each data packet, whereas each data packet which has to be checked is received directly from the open system interconnection (OSI) layer 2 (link-layer) before confirming security of the data packets, and/or

examining each data packet for valid IP headers whereas the structure of each data packet is checked for validity before it is forwarded to the target system and each invalid packet is rejected, and/or

examining the data packet by especially checking the length and the checksum values for conformity of the values in the TCP or IP header with the structure of the data packet, and/or

answering outgoing data traffic from the secured system using TCP/IP fingerprint protection so that the requesting external systems are neutralized, by using default protocol identifiers, and/or

blocking of each user datagram protocol (UDP) network packet for avoiding attacks at the secured systems via the network protocol UDP, by selectively registering and unblocking services required to be reached via UDP ports whereas for these UDP ports messages are explicitly admitted and the other UDP ports stay closed, and/or

identifying length restrictions of Internet control message protocol (ICMP) whereas only ICMP messages with a predefined maximal length are identified as valid data and others are rejected, and/or

excluding specific external IP addresses from communicating with the target system, and/or

examining packet-level firewall function of incoming and outgoing data packets by applying freely definable rules and as a result of these rules the data packets are either rejected or forwarded to the target system, and/or

excluding of specific services and/or users and/or redirection of services to other servers to provide protection of the reachable services of the target system.

According to the teaching of the present invention the task addressed hereinabove is also solved by a data medium containing a computer software for the recognition of and defense against attacks on server systems of network service providers and carriers for the use in an electronic device that is integrated into a computer network and contains one or more of the program steps stated immediately above and incorporated herein. Preferably the data medium is represented by an EPROM and is a component of an electronic device. This electronic device may be a slot device for use in a computer, a custom circuit board for use in an existing computer or a dedicated computer.

Alternatively the task is also solved by a computer system which is connected to a network like the Internet, an intranet, an extranet, a virtual private network and the like, containing one or more computers which are configured as server computers or client computers. Inserted into a data line to be protected and which connects the network and the server or client computers is an electronic device which is provided with a data medium containing a computer software which contains one or more of the program steps set forth in detail above.

Furthermore the solution of the task relating to the invention is accomplished by a computer software product containing computer program codes for the recognition of and defense against attacks on server systems of network service providers and carriers by use of an electronic device that is integrated into a computer network and contains this computer software product. The computer software product contains one or more of the program steps, again, as set forth in detail above.

A special advantage of the solution relating to the invention is that not only each of the secured systems are protected against DoS and DDoS attacks but so is the computer software that performs the method of recognition of and defense against attacks on server systems of network service providers and carriers.

The protection against DoS and DDoS attacks makes up the kernel of the method relating to the present invention. The goal of these attacks is to stop the target computer or computers (i.e., to crash them by a flood of connection request packets). As a result the attacked systems are no longer able to react to communication requests. By means of an intelligent set of rules and pursuant to the teaching of the present invention, each of the secured systems are protected against attempts to attack via DoS and DDoS attacks. Special treatment of the incoming packets is assured by letting only authorized requests pass the secured data line so that the target systems (e.g., world-wide-web or email servers) are not crashed by such mass flood-type DoS and DDoS attacks.

An electronic device adapted for use with the inventive system needs no IP address because the data packets to be checked are taken directly from the OSI layer 2 in the link-layer security module. As a result configuration changes of the existing network environment regarding logical addressing (IP routing) are also not required. The hardware performing the method is therefore not an addressable network component so an attack cannot be specifically aimed at the electronic device and the device is essentially not detectable by users of the network.

Many TCP/IP implementations react incorrectly if the structure of an IP header is invalid. If each IP packet's structure is checked for validity before it is forwarded to the target system, it is assured that only IP packets with correct structure get to the target systems.

To a hacker attempting to mount a DoS or DDoS attack successfully, knowledge of the running operating system is extremely important so the hacker can mount a DoS or DDoS attack specifically directed at weak aspects of such operating system. These are so-called “aimed attacks” because they are primarily based on knowledge of the operating system of the target computer. TCP/IP fingerprint routines examine the behavior of the TCP/IP implementations of the target system and are able to derive information about the operating system. The present invention, in part due to its functionality, assures that the attacker cannot make conclusions on the identity or operation of the operating system by analysis of the returned packets.

There are different methods or attacking computers in a TCP/IP network. One of these methods is the sending of ICMP messages with an inappropriately high packet length. The reason for the restriction of ICMP packet length as a part of the present invention is that as a result of exceeding the restriction, all such ICMP messages are automatically rejected.

The ability to exclude specific external IP addresses increases the total security of a given network system. For example, if it is detected that a computer from outside of the network probes the network, for example, to determine which ports of the system are open and thus able to be attacked, it is possible to reject all the data packets originating from that particular outside computer. The list of blocked computers can later be modified so that following a DoS or DDoS attack, any now blocked, but formerly valid, IP addresses may be removed or reviewed, as applicable or desired from the list of blocked computers.

Additional to the packet level firewall function on the IP packet layer the invention is extended by security mechanisms relating to the reachable services which are reached via the IP protocols HTTP, FTP, NNTP, POP, IMAP, SMTP, X, LDAP, LPR, Socks or SSL and the like. The exclusion of specific services or users or the redirection of service requests to other servers is assured by this functionality. Easy configuration of this component is enabled by an administration user interface for setting these restrictions.

With the method relating to the invention, the software and the device containing the computer software monitor every incoming and outgoing message. When an attack is detected a system according to the present invention intervenes specifically and selectively blocks the suspicious data packets without influence on the regular data traffic. All regular data is forwarded without appreciable delay so the operation of the solution relating to the invention causes no disruption of work or communication to users of the protected system. This is valid also with high speed and high data volume Internet connections (e.g., 100 Mbit/s or greater)

Further measures and arrangements of the method relating to the present invention result from the sub claims 2 to 6 appended hereto and incorporated herein. To wit, in the event a limitation in length of a ICMP packet is exceeded, the invalid length of the ICMP packet is reduced to an approved length; with respect to the limitation in length of ICMP packets, all single ICMP types of message are entirely blocked; and the rules for the packet-level-firewall-function are determined on the basis of certain criteria of an IP packet, especially concerning exclusions, restrictions and logging editions.

Furthermore, in one embodiment of the present invention the length restriction of ICMP packets for invalid-length packets are reduced to valid packet length values; in addition, certain specific ICMP message types may be blocked entirely.

In another embodiment of the packet-level firewall functions according to the present invention the appropriate rules are defined on the basis of special criteria of the IP packet especially referring to exclusions, restrictions and logging editions. Accordingly, the specially adapted administration software creates a configuration file for the firewall. Preferably, in a further embodiment of the present invention all administrative actions for the electronic device are done simply from a remote console or via secured network connections so that controlled network configuration and flawless network operation are ensured.

Furthermore, the access to the target system may be restricted in detail by adjustable time configurations.

The present invention consequently comprises specially configured hardware, preferably based on widely available PC technology, integrated microchips with additional specially developed microcode, but not necessarily limited thereto. Further, a specially developed software program, based on the OSI link-layer of the system, contains a unique method to react to the miscellaneous problems presented by different system routines. The present invention also assures that the data stream in total for the OSI-layer 3 up to the OSI-layer 7 is already selected on the link-layer (OSI-layer 2) and at that level rigorously examined against security related contents in all upper layers. An essential feature of the invention is consequently, the proactive extension for a low level data line of active intelligence to detect attack-relevant contents in the whole data stream. Because of the fact that the implemented methods of detection are able to detect also “flood-attacks,” and another attacks for the “IP-stack” and for various “operating systems,” there are additional beneficial and unique characteristics implemented thereby. The invention (hardware and software combined) protects itself and all correctly connected systems thereof against the various modes of attack. The combined solution should be installed between a screening router and the normal router which is connected to the network systems. With the variety of implemented methods made possible by the present invention, which can be practiced in whole or in part (and due to the modularity offered by the invention), the various attacks in the whole IP data stream (including the Internet Protocol itself) will be successfully detected and defended. The data is independent of the IP-header or IP-address directly from the link-layer selected and will be checked by a kind of “objective observer” (i.e., the hardware/software combination according to the present invention), for the presence of attack-related contents, messages and data. As noted above, the part of the system where this “objective observer” is running needs no IP address. Therefore it cannot be attacked on the IP-level, which further differentiates the present invention. With respect to all active network components, the system according to the present invention is hidden and unreachable.

In summary, one essential element of the present invention is the active detection of DoS and DDoS attacks. This is due to the combined hardware and software solution of the present invention. On the server side, the server systems can be protected against DoS- and DDoS-attacks. On the provider side, the lines can be protected against the still-possible associated line flooding associated with DoS and DDoS attacks that pass through a given provider. It is very important to note that existing firewall systems are not to be replaced, but instead used as essential extension of the security model according to the teaching of the present invention.

It perhaps goes without saying that the aforementioned and following characteristics are not mutually exclusive but can be utilized in other combinations or on their own, all within the scope of the present invention.

### BRIEF DESCRIPTION OF THE DRAWINGS

The basic approach of the invention is shown in the following description with some implementation examples described in the drawings in which like elements are referred to by common reference numerals.

FIG. 1 is a schematic description of a computer system corresponding to the present invention which is connected to the Internet in a small network environment.

FIG. 2 is a schematic description of a computer system corresponding to the present invention which is connected to the Internet in a medium-sized network environment.

FIG. 3 is a schematic description of a computer system corresponding to the present invention which is connected to the Internet in a large network environment.

FIG. 4 is a schematic description of a procedure corresponding to the present invention establishing a connection with the authorized use of a protocol.

FIG. 5 is a schematic description of a procedure corresponding to the present invention building up a connection with the non-authorized use of a protocol.

FIG. 6 is a schematic description of a procedure corresponding to the present invention failing to establish a connection.

FIG. 7 is a schematic description of a procedure corresponding to the present invention after establishing a connection with authorized flow of data.

FIG. 8 is a schematic description of a procedure corresponding to the present invention after establishing a connection with non-authorized flow of data.

FIG. 9 is a schematic description of the protocol levels protected through an electronic device according to the present invention.

FIG. 10 is a schematic description of the examination of valid IP headers.

FIG. 11 is a schematic description of the examination of an IP packet.

FIG. 12 is a schematic description of the examination of adjustable UDP connections.

FIG. 13 is a schematic description of the length limitations of ICMP packets.

### DETAILED DESCRIPTION OF THE ILLUSTRATED EMBODIMENTS

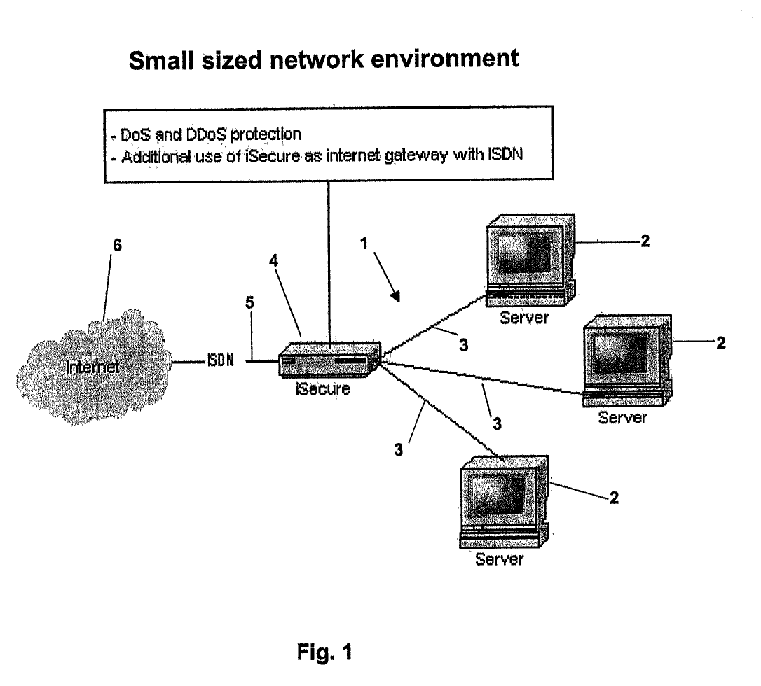

The computer system according to FIGS. 1 to 3 consists of several server computers (2) which are possibly mutually connected through further data lines which are well known and not described in further detail herein. The server computers are connected to an electronic device (4) via at least one data line (3) each. This device shows a data carrier constructed as an EPROM (which are also well known and which are not described in further detail herein) which implements a computer program to recognize and to refuse any DoS and DDoS attacks on server systems of network providers and operators.

The electronic device (4) is connected to the Internet (or other remote network) via an ISDN data line (5) according to FIG. 1. The electronic device serves as protection of DoS and DDoS attacks and adds enhanced functionality as an Internet gateway via ISDN. In addition to this, the electronic device (4) is equipped with an Ethernet and an ISDN adapter. Beside the protection of the systems in the Local Area Network (LAN) against DoS and DDoS attacks, the electronic device (4) is used as a router for the access on services of the Internet. The establishing of the ISDN connection is, as a standard, effected whenever a communication access to an external network is requested. The establishing of a connection is effected automatically if the computer program contained in the EPROM within the electronic device (4) does not transfer any further network packets after a certain time frame. One can modify this standard attribute through a corresponding configuration routine as is known in the art.

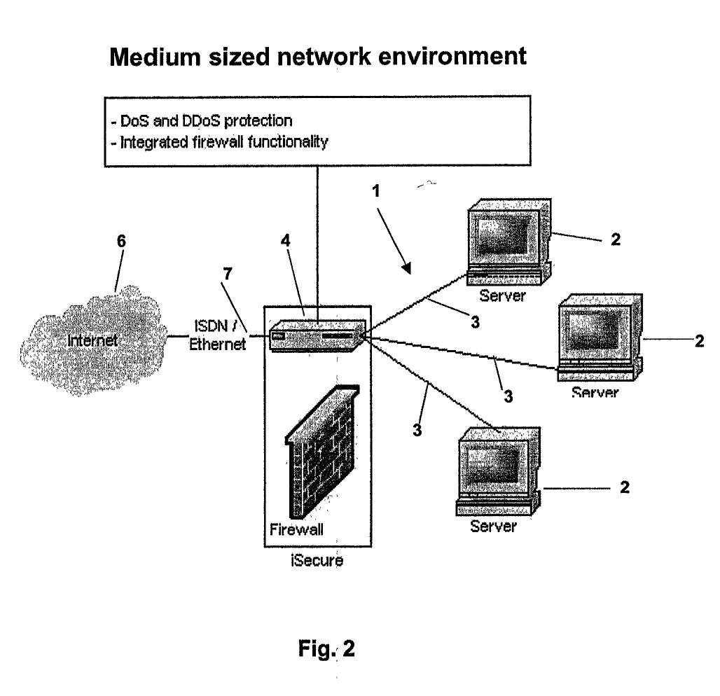

The electronic device (4) is, for instance, connected to the Internet (6) via an ISDN/Ethernet data line (7) according to FIG. 2. In addition to this, the electronic device (4) integrates a non-visible firewall-function-module. Thus it can be used as integrated firewall router, possibly via a further dedicated router. The server computers (2) or personal computers, respectively, of the internal network use the electronic device (4) with the EPROM including the computer program for protecting and refusing attacks on server systems of network service providers and operators as they transition data onto the Internet via Ethernet or ISDN. Moreover, the electronic device (4) protects the internal systems against DoS and DDoS attacks. With this, incoming and outgoing IP packets are forwarded or aborted by means of defined rules. Thus, the ultimate access to the services for specific third parties and the public in general is either approved or denied according to defined rules on the local systems.

The rules necessary for the individual functions are established and modified through a configuration program which establishes a readable configuration set according to simplified inputs of users as well. The functions offered by the electronic device (4) include the abilities of recognizing and refusing attacks on server systems of network service providers and operators which may be freely configured to a large extent to customize the detection and subsequent responses. Thus are preferably adapted and optimized for use within a “home network.”

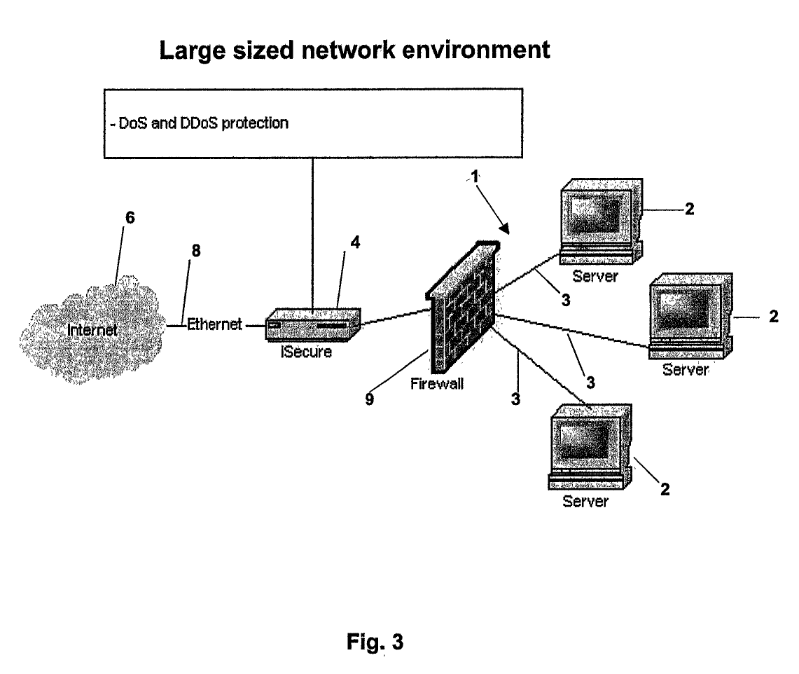

The way of describing the invention according to FIG. 3 shows the firewall-function-module (9) being separate. That is to say switched separately between the server computers (2) and the electronic device (4) including the computer program for recognizing and refusing attacks on server systems of network service providers and operators. In this form of the invention, the electronic device (4) is connected to the Internet (6) via an Ethernet data line (8) and offers the protection necessary against DoS and DDoS attacks (flood attacks). Only those network packets will be forwarded to the firewall for further handling which do not cause any harm to the applicable target system concerned, as determined by the applicable rules, restrictions and logging. After that the decision whether to accept or deny forwarding the network packets is undertaken based on the then-present criteria of the network firewall mechanism.

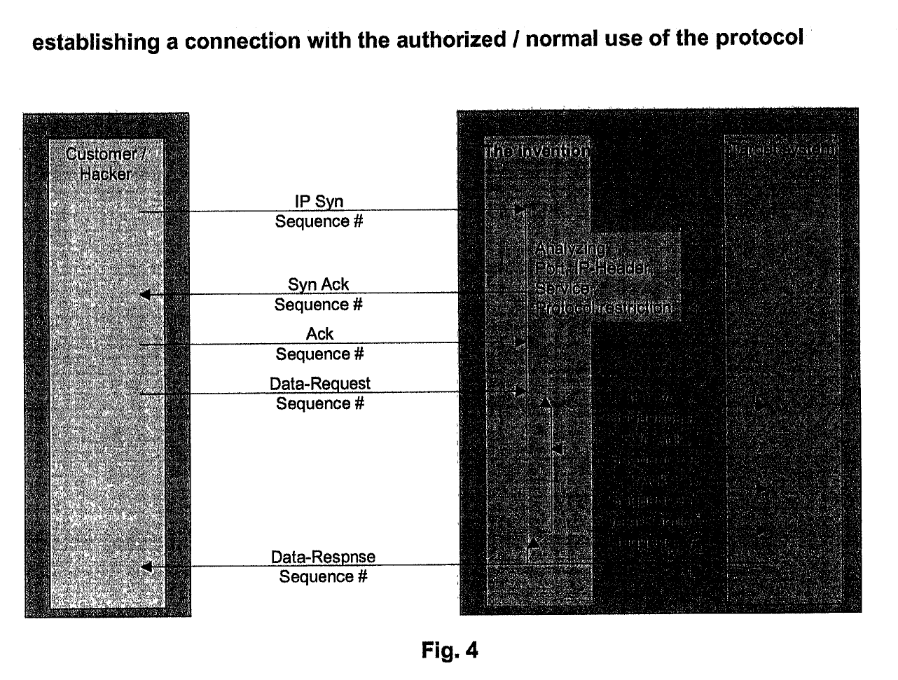

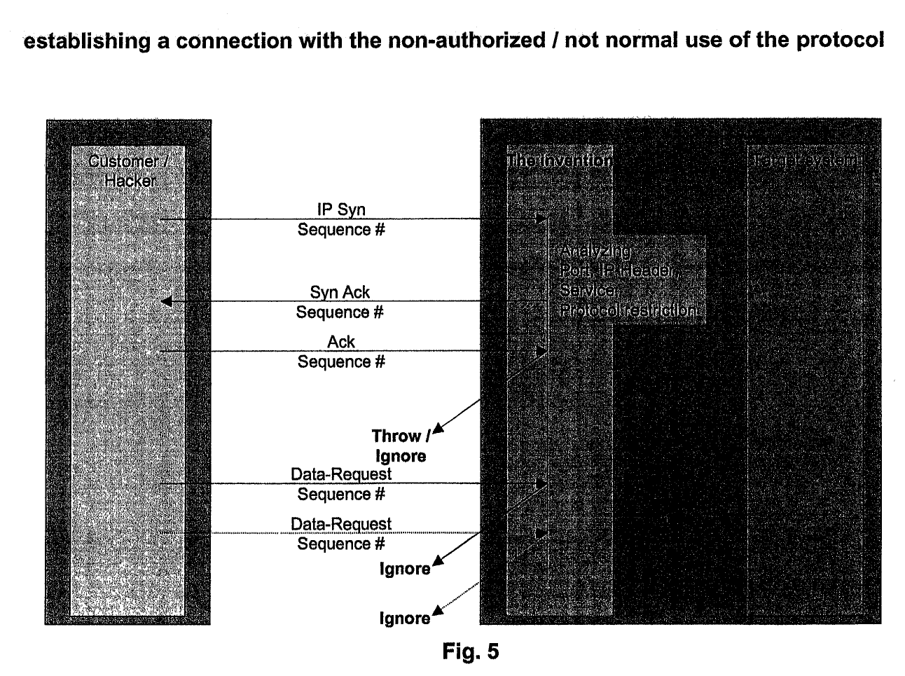

FIG. 4 shows a schematic description of the procedure when establishing a connection with authorized use of protocol whereas FIG. 5 shows the procedure when establishing a connection with non-authorized use of protocol.

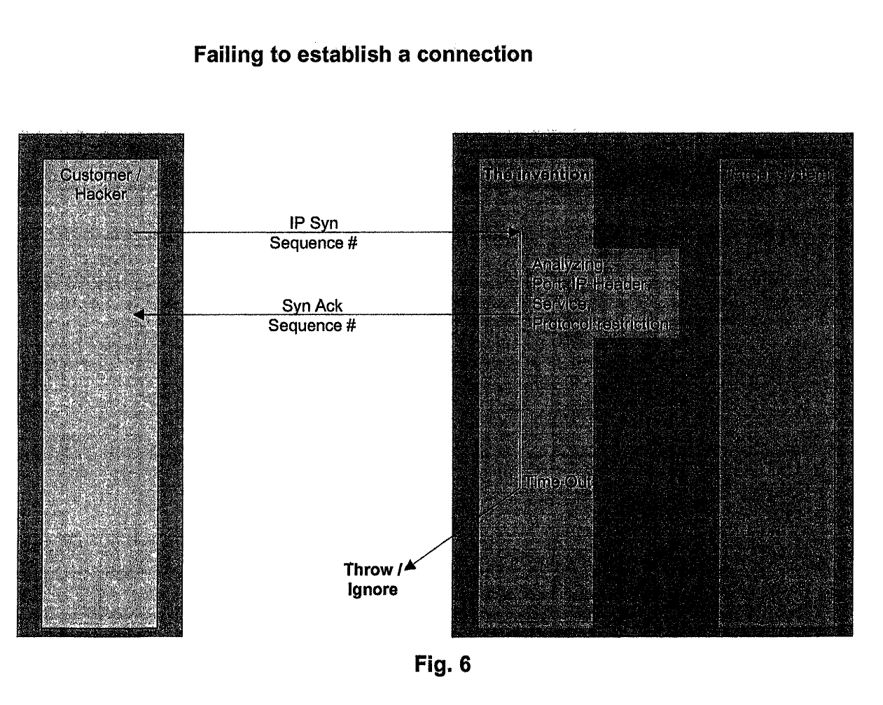

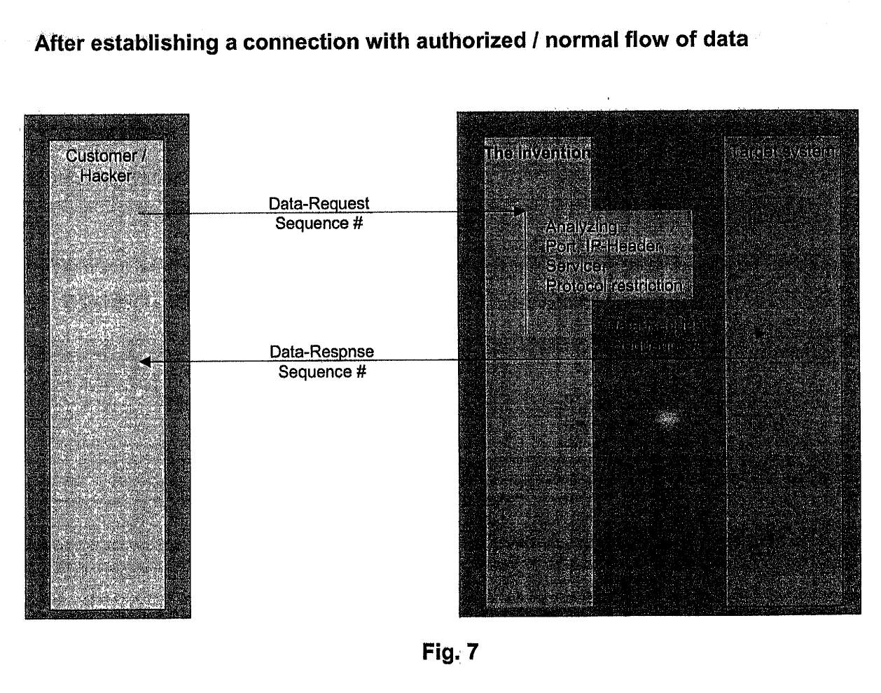

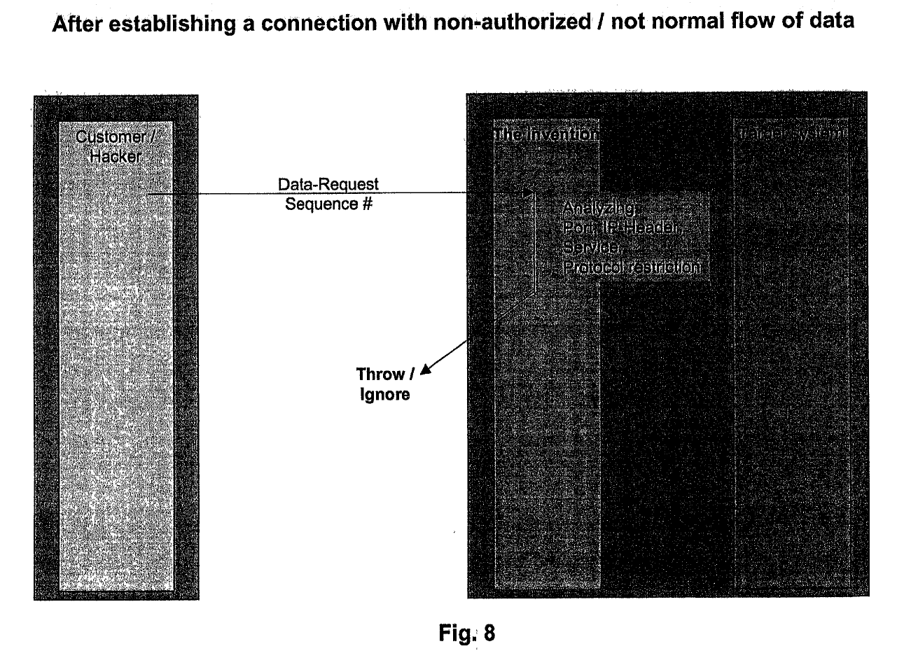

FIG. 6 shows the procedure corresponding to the invention with the failure to completely establish a connection. FIG. 7 schematically simulates the procedure after establishing a connection with authorized flow of data and FIG. 8 simulates the procedure after establishing a connection with a non-authorized data flow.

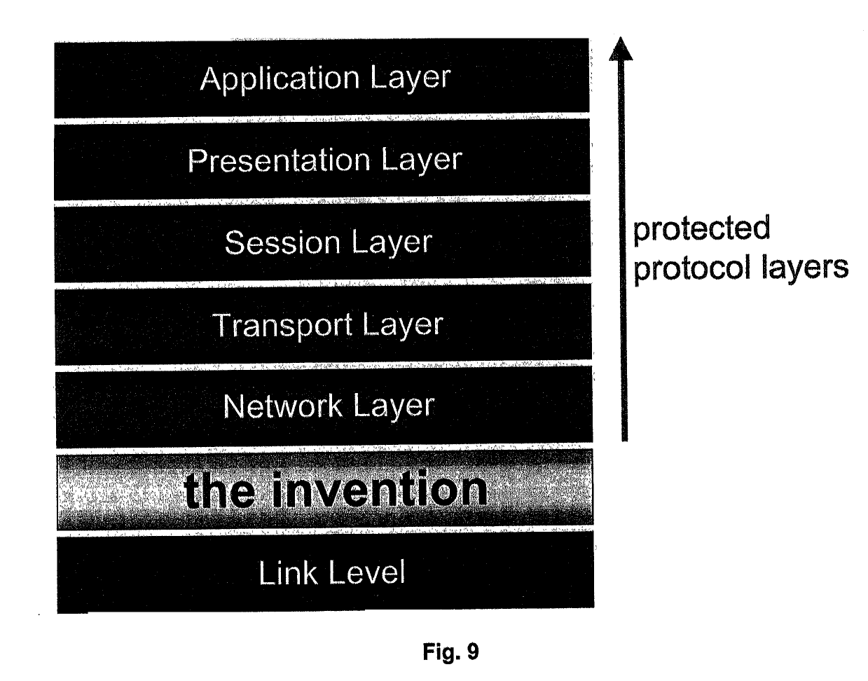

FIG. 9 shows a schematic description of the protocol levels being protected through an electronic device with the EPROM; including the computer program operatively protecting and refusing attacks on server systems of network service providers and operators.

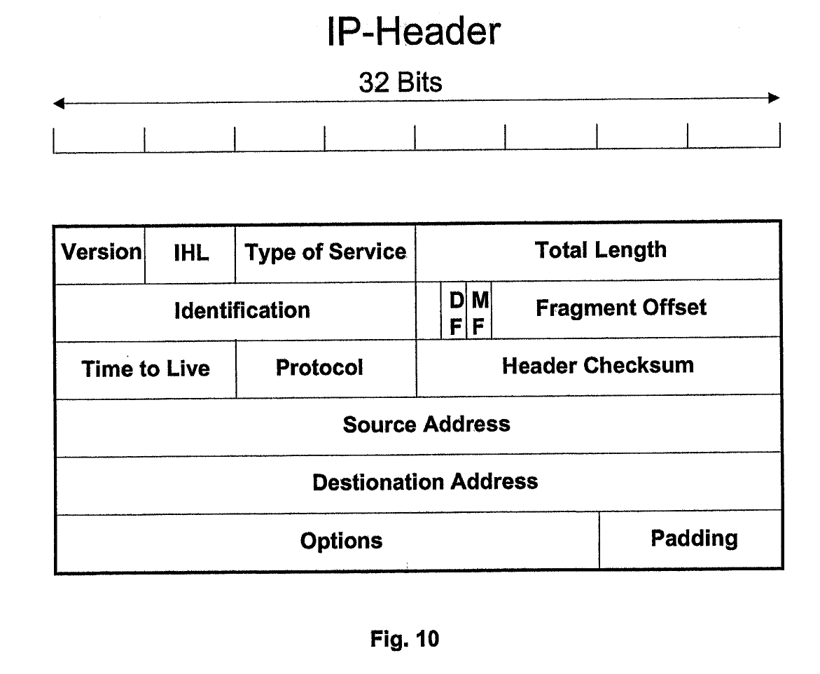

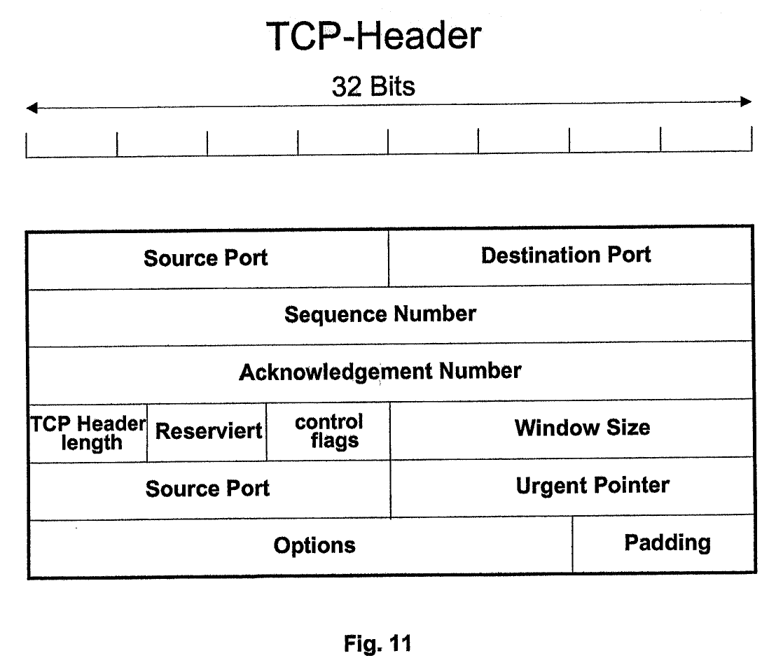

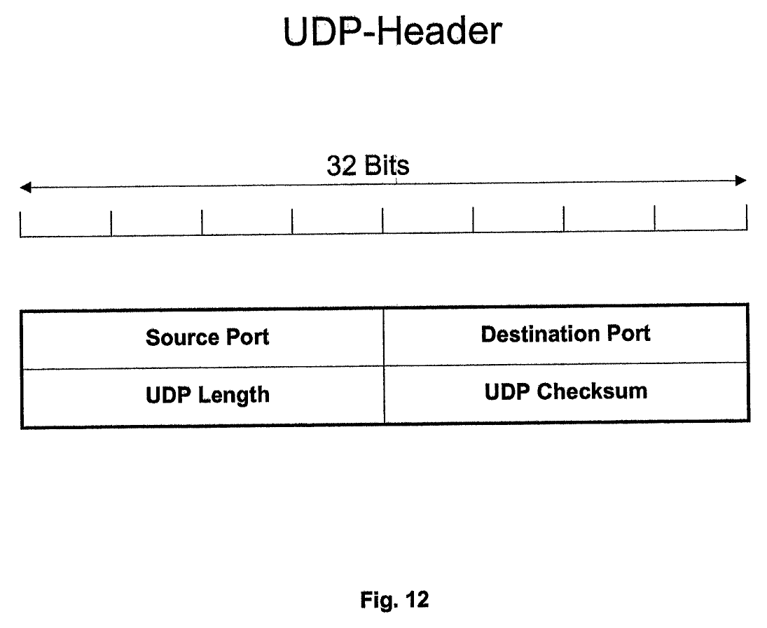

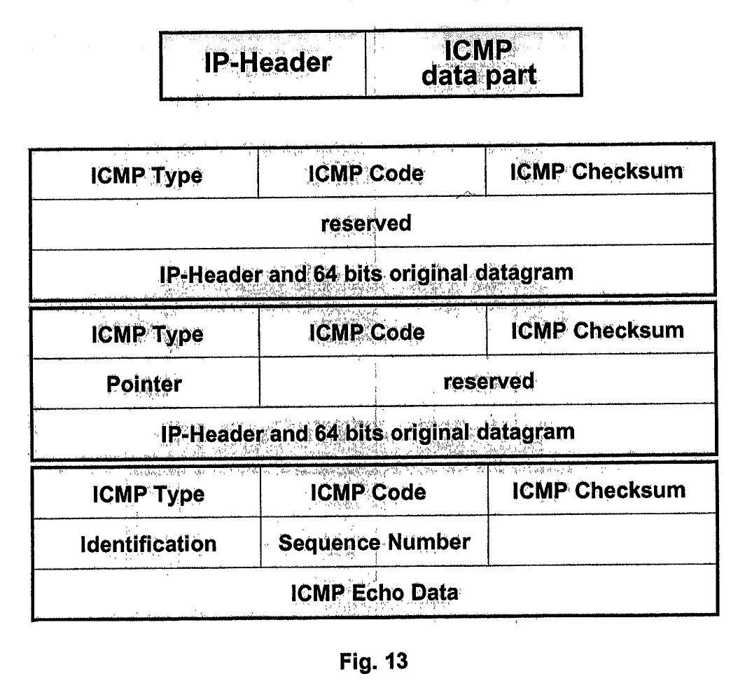

FIG. 10 describes the examination of valid IP headers. FIG. 11 describes the examination of an IP packet. FIG. 12 describes the examination of adjustable UDP connections and FIG. 13 describes the length limitations of ICMP packets.

1. A method for recognizing and refusing DoS and DDoS attacks on server systems of network providers and operators by means of an electronic intermediary device implemented in a computer network, wherein the electronic intermediary device contains a computer program for carrying out defense against the DoS and DDoS attacks, for each one of an IP connection request, performing the following steps:
registering the IP connection request;
checking the validity of the registered IP connection request, and while the registered data packet is being checked for validity;
sending a periodic acknowledgement signal to preserve the network connection, and after receiving confirmation of the validity of the IP connection request;
forwarding a data packet associated with the IP connection request to a target system which was the subject of the IP connection request.
